(19) United States
(12) Patent Application Publication
(10) Pub. No.: US 2019/0008319 A1
(43) Pub. Date: Jan. 10, 2019

(54) Disposable Cooking Pan with Drip Tray

(71) Applicant: Gilbert P. Robles, San Antonio, TX (US)

(72) Inventor: Gilbert P. Robles, San Antonio, TX (US)

(21) Appl. No.: 15/644,278

(22) Filed: Jul. 7, 2017

(51) Int. Cl. A47J 37/06; A47J 36/02; A47J 37/01

(52) U.S. Cl. CPC A47J 37/067; A47J 37/01; A47J 36/022

(57) ABSTRACT

The current invention is a disposable cooking pan with a drip tray. The trays will be 1.5″ in depth and various lengths and widths to fit various cooking purposes. The cooking pans will be made of aluminum or other suitable materials which distribute heat, are durable, and are affordable. The pan can be used in the oven is designed to be used on a grill. The food is placed on a metal grating, that is near the top of the pan. Fat drippings from the food pass through the grating and fall into the bottom of the pan. When the food is prepared, the tray can be disposed off after cooking to a safe temperature.

### CROSS-REFERENCES TO RELATED APPLICATIONS (IF ANY)

None.

### BACKGROUND

### 1. Field of the Invention

This invention relates to cooking trays and particularly to disposable trays for cooking meat products.

### 2. Description of Prior Art

Cooking meat is typically done in an oven or a grill. Grills style cooking provides a healthier option, as the meat doesn't cook in its own fats, but this results in a greater amount of cleanup. Several specialized devices, such as the Foreman Grill exist, which are essentially miniature grills. Many people use disposable pans to cook meat in ovens, to avoid purchasing additional equipment. Grocery and big box stores carry disposable pans of many sizes, and are typically made of aluminum foil. Disposable pans allow a cheap option to cook meat, without having to clean up as liquids and fats leak off.

There is still room for improvement in the art.

### SUMMARY OF THE INVENTION

The current invention is an aluminum pan intended to be a disposable tray for cooking meat. There is a grate near the top and space below to collect meat drippings.

The pans are made of aluminum or other stable, disposable materials that will distribute heat for cooking purposes. There are various sizes for different cooking purposes. The pans are 1.5″ to 2″ deep.

There is a metal grating at the top of the pan, on which the cooking item rests. The meat drippings will fall into the bottom of the pan. This keeps the meat from sitting in its drippings, while still having a clean-up-free cooking process.

### BRIEF DESCRIPTION OF THE DRAWINGS

Without restricting the full scope of this invention, the preferred form of this invention is illustrated in the following drawings:

FIG. 1 shows a top view of the pans, with 3 sizes shown;

FIG. 2 shows the pan from another angle;

FIG. 3 shows the pan from another angle;

FIG. 4 shows the pan from the front;

FIG. 5 shows the drippings flowing through the pan.

### DESCRIPTION OF THE PREFERRED EMBODIMENT

There are a number of significant design features and improvements incorporated within the invention.

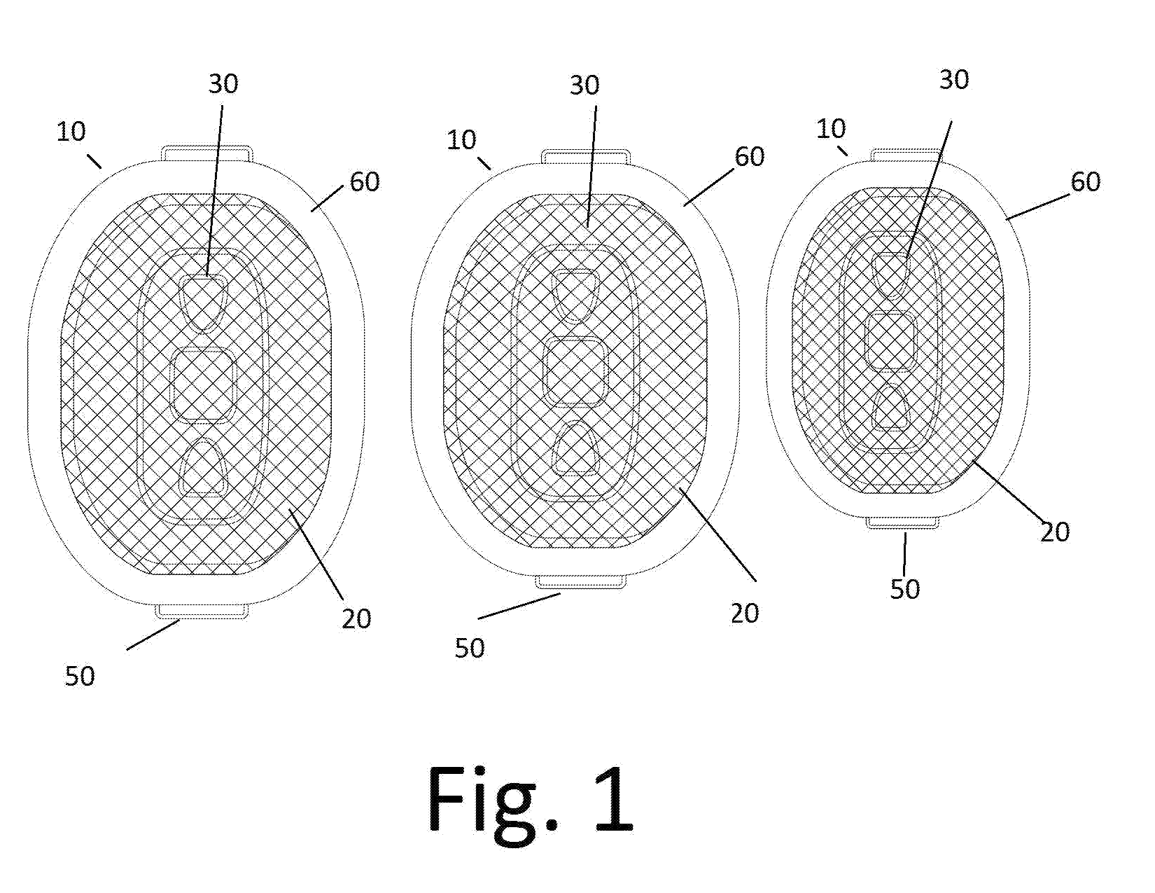

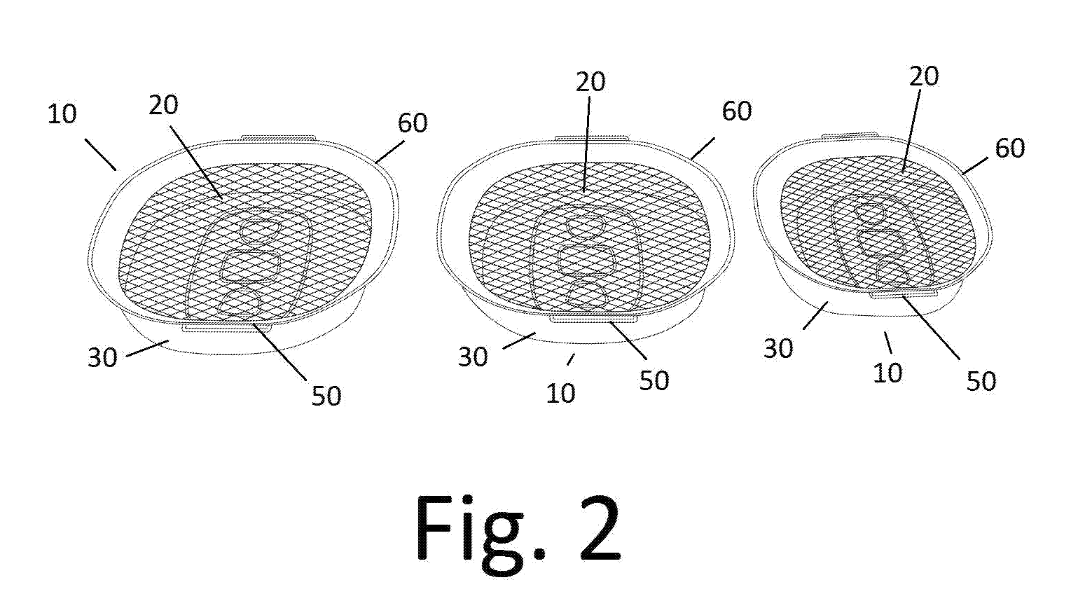

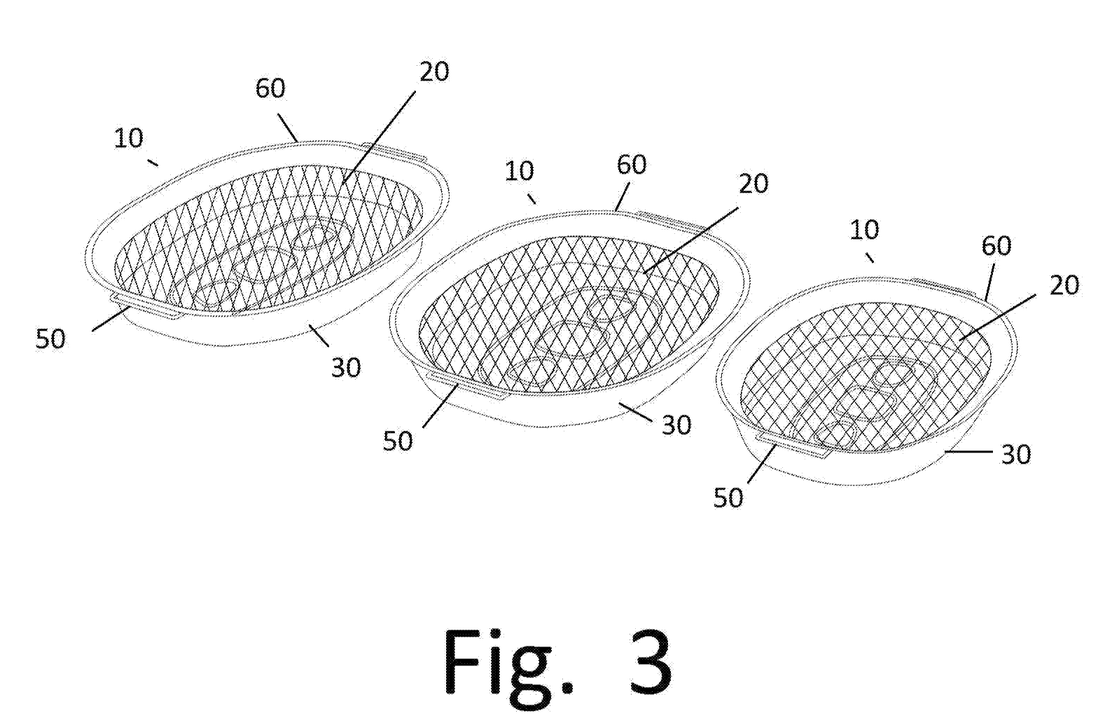

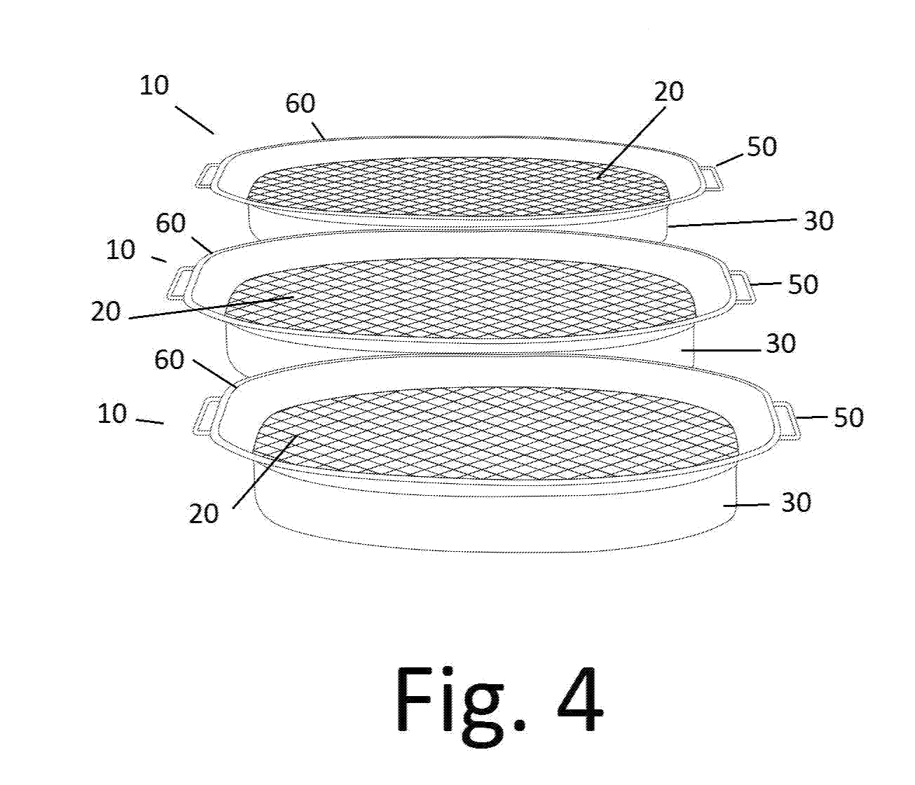

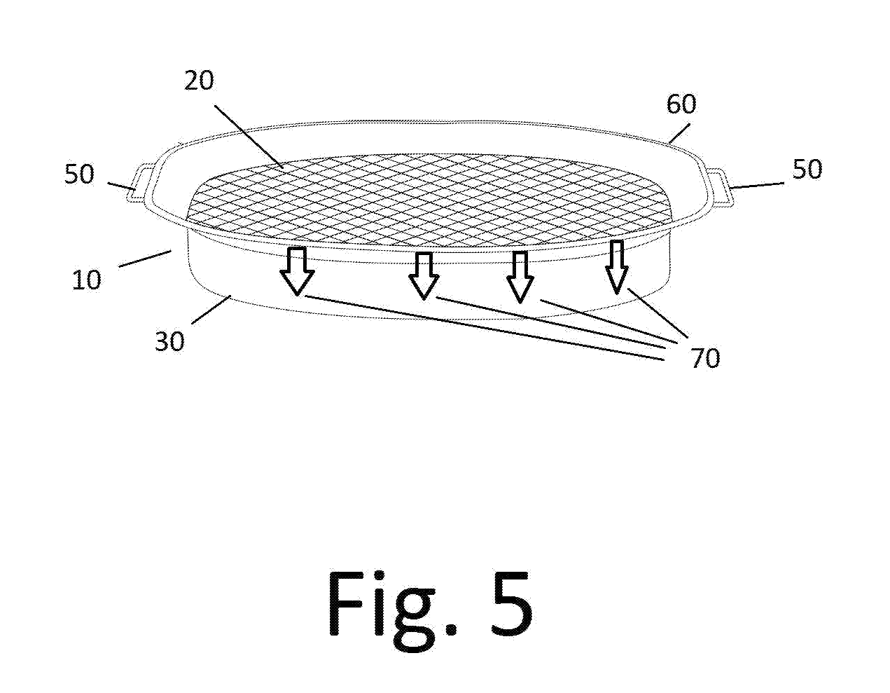

As shown in FIG. 1 through 5, the current invention is an aluminum pan 10 intended to be a disposable tray for cooking meat. There is a grate 20 near the top and space 30 below to collect meat drippings. The pan 10 is designed to be used on a grill or in an oven.

The pans 10 are made of aluminum or other stable, disposable materials that will distribute heat for cooking purposes. There are various sizes for different cooking purposes. The pans 10 are 1.5″ to 2″ deep in the preferred embodiment.

There is a metal grating 10 at the top of the pan 1, on which the cooking item rests. The meat drippings 70 will fall into the bottom of the pan 10. This keeps the meat from sitting in its drippings, while still having a clean-up-free cooking process.

In the preferred embodiment, the pans 1 will come in three sizes: Small: 13½×9⅝×2¼, Medium: 16×13⅛×3⅛, and Large: 17¼×12⅜×2 27/28.

The current invention is a disposable foil pan 10 with a drip tray approximately 1½ to 2 inches off the bottom reservoir 30 of the pan so when you are cooking items like ribs, chicken, or any other food that will drip your food is not sitting in the drippings 70 and all that extra fat, this is a pan 20 that is disposable and should be inexpensive to purchase.

The pans 10 have a rim 60 around the edge of the pan 10 and would have handles 50 to assist the user in handling the pan 10. The grating 20 will sit below the rim 60 with the rim 60 angled downward towards the grating 20. The grating 20 will cover the top of the pan 10. The grating 20 has bars crossed with openings to allow the dripping 70 to flow through and not be in contract with the meat or food. The bottom reservoir 30 is at the bottom of the pan 10 below the grating 20.

### ADVANTAGES

The innovative disposable cooking pan with drip tray provide a clean-up-free cooking method, while having the health benefits of a drip tray. Like grills with drip trays, this cooking pan will produce healthier meals by moving fat drippings away from the cooking food. But, like disposable trays, this cooking pan has no clean-up after food is finished. In its simplicity, it combines the strengths of drip trays and disposable cooking trays, while eliminating the weaknesses. The innovative disposable cooking pan with a drip tray will allow anyone to produce high quality, healthy cuts of meat, regardless of location or weather. No need to have a grill to produce cook-out quality food. This helps to make healthier food for people to eat.

Although the present invention has been described in considerable detail with reference to certain preferred versions thereof, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device to keep drippings away from food comprising:
a disposable pan with a grate and a bottom reservoir.

2. The device to claim 1 further comprising:
Being made of aluminum.

3. The device to claim 1 further comprising:
Having a rim around the top of the pan.

4. The device to claim 1 further comprising:
Placing food on the grate and having the drippings drip into the bottom reservoir.

5. The device to claim 1 further comprising:
Having a plurality of handles.
